(19) United States
(12) Patent Application Publication
(10) Pub. No.: US 2014/0050556 A1
(43) Pub. Date: Feb. 20, 2014

(54) APPARATUS AND METHOD FOR ALIGNING AND HOLDING EGG CARTONS

(71) Applicant: Tekni-Plex, Inc., King of Prussia, PA (US)

(72) Inventors: Richard L. Ramirez, Lawrenceville, MA (US); Mark A. Bergeron, Monroe, GA (US)

(73) Assignee: Tekni-Plex, Inc., King of Prussia, PA (US)

(21) Appl. No.: 14/062,415

(22) Filed: Oct. 24, 2013

Related U.S. Application Data
(63) Continuation of application No. 13/186,809, filed on Jul. 20, 2011.

(51) Int. Cl. B65D 21/02; B65G 57/02; B65D 85/32

(52) U.S. Cl. CPC B65D 21/0219; B65D 85/32; B65G 57/02
USPC 414/801; 206/508

(57) ABSTRACT

Egg carton and method for transporting filled egg cartons that enables ready stacking of multiple cartons, one filled carton on top of another, for stable transport with or without the use of exterior containers for holding together the stack as are typically used in the industry,

### FIELD OF THE INVENTION

The present invention relates to plastic egg cartons and more particularly to an egg carton having features that enable aligning and stacking multiple cartons for transport.

### BACKGROUND

Many factors are taken into consideration in the design of egg cartons. Egg protection, stackability, transportability, aesthetic appearance, print surface area, strength, weight, nestability/denestability, adaptability to accommodate various size eggs, and consistent manufacturing are factors which may be considered to varying degrees in the design of an egg carton.

Polystyrene egg cartons are formed and trimmed from a single sheet of polystyrene foam material to integrally define a lid and a tray connected by a hinged area. The formed egg cartons are transported, typically by conveyer belt, to a printing machine and imprinted with an egg distributor's trade style, government mandated nutritional information, and retail information, such as UPC labels. The egg cartons are then nested one within another and packaged in bags or pallets for shipping to egg distributors. The distributor then fills the cartons with eggs at a filling station and transports the filled cartons to another location. The process of transport of filled egg cartons requires that cartons first be stacked in a stable arrangement such that when physically moved on a pallet the multitude of stacked, filled cartons are transportable without risk of falling off the pallet, falling out of the stacked arrangement, and/or otherwise moving or collapsing so as to cause damage to the eggs.

### SUMMARY OF THE INVENTION

The present invention provides a plastic egg carton and a method for aligning and stacking filled egg cartons, one filled carton on top of another, for stable transport without requiring the use of additional packaging, such as corrugated cases, wire or plastic baskets, or the like. By keeping the stacked cartons squarely aligned without the need for master containers, the invention reduces overall packaging cost, waste, and protects fragile eggs. The new carton is suited for direct pallet stacking, such as on grocery pallets 40″×48″, optionally with slip sheets between every 4, 5 or 6 layers, enabling the cartons to be stacked 20 to 25 cartons high.

The new cartons can, if desired, be packaged or otherwise supported in, for example, existing standard master corrugated containers (e.g., full or half case), plastic or wire baskets, carts, wrapped in film or the like.

In one embodiment, a pair of contoured bosses are provided on the lid top, disposed on opposite ends of a centerline of the carton, either widthwise or lengthwise, to restrict movement of adjacent cell bottoms (of an adjacent carton). The height of the lid bosses can be adjusted, with for example a minimum height of 3/16″ being effective to securely hold a weighted carton stack on top (e.g., 20 to 25 cartons high). The cartons may be made of polystyrene foam, of dimensions and thickness that are standard in the industry.

In accordance with one embodiment of the invention, an egg carton is provided comprising a stackable egg carton of plastic material having a lid and a tray hingedly connected to the lid, said egg carton having a width and length;
the tray having a plurality of cells for receiving individual eggs, the cells being arranged successively adjacent each other along the width and along the length of the carton,
each cell having an under-surface forming a bottom of the tray,
the under-surface of the cells forming a series of recesses between adjacent cells; and
a pair of bosses projecting upwardly from an outer top surface of the lid, the pair of bosses being arranged at opposing ends along the length or width of the carton for positioning between two recesses of an adjacent carton stacked on top thereof, wherein the two recesses restrict movement of the bosses for maintaining the cartons in a stacked configuration.

According to one embodiment of the invention, the lid has a trough that extends between the bosses.

According to one embodiment of the invention, the trough extends up to and terminates at the bosses.

According to one embodiment of the invention, the trough has a width that is about the same as a width of the bosses.

According to another embodiment of the invention, the bosses have an upper surface contour that is complementary to a contour of the two recesses to resist lateral and/or longitudinal movement of the cartons relative to each other.

According to one embodiment of the invention, the pair of bosses is disposed at about the centerline of the length or of the width of the carton.

According to one embodiment of the invention, the bosses are arranged along or adjacent the opposing lengthwise or widthwise edges of the carton.

According to one embodiment of the invention, the bosses are disposed beyond the lengthwise or widthwise edges of the lid and are supported by angled portions of a lid sidewall.

According to one embodiment of the invention, the bosses are arranged along or adjacent the lengthwise edges of the carton.

According to one embodiment of the invention, the plastic comprises a thermoplastic which is foamed or unfoamed, and comprises one or more of polystyrene, polyester, polyolefin, and poly(lactic acid), including homopolymers, copolymers, mixtures and blends thereof, and including virgin and reclaimed materials.

According to one embodiment of the invention, the plastic comprises polystyrene foam.

According to one embodiment of the invention, a stack is provided comprising a plurality of stacked egg cartons.

According to one embodiment of the invention, where the stack comprises at least four layers of the cartons stacked one above the other.

According to one embodiment of the invention, the stack rests on a pallet.

According to one embodiment of the invention, the stack includes a stacking sheet between every 4, 5 or 6 layers of cartons.

According to one embodiment of the invention, the stack is disposed on a pallet for transport without exterior support to the stack.

According to one embodiment of the invention, the stack is disposed on a pallet for transport with only an outer film wrap supporting the stack.

In accordance with another embodiment of the invention, a plastic egg carton is provided for packaging a plurality of eggs, said egg carton having a width and a length, the carton comprising:
a lid and a tray hingedly connected to the lid;
the tray having a plurality of cells for receiving individual ones of the eggs, the cells being arranged successively adjacent each other along the width and along the length of the carton,
the lid having a top surface and being pivotable around the hinged connection into a closed position enclosing the cells,
each cell having an under-surface forming a bottom of the tray, the under-surface of the cells forming a series of recesses between adjacent cells,
the top surface of the lid having a pair of bosses projecting upwardly from the top surface of the lid, the pair of bosses being arranged at opposing ends along the length or width of the carton;
the bosses having an upper surface contour that is complementary to a selected contour of at least two recesses on the bottom, the at least two complementary recesses being arranged on the bottom for simultaneous receipt of a pair of bosses on the lid of a carton when the lid is in a closed position;
wherein when the pair of bosses are received within the at least two complementary recesses on the bottom of another one of the cartons, the complementary contours of the bosses and recesses resist lateral and/or longitudinal movement of the cartons relative to each other.

According to one embodiment of the invention, the tray comprises a 2×6, 3×6, 4×6, 5×6 or 6×6 matrix of cells.

According to one embodiment of the invention, the plastic comprises a thermoplastic which is foamed or unfoamed, and comprises one or more of polystyrene, polyester, polyolefin and poly(lactic acid), including homopolymers, copolymers, mixtures and blends thereof, and including virgin and reclaimed materials.

According to one embodiment of the invention, the plastic comprises polystyrene foam.

According to one embodiment of the invention, the lid comprises a generally planar sheet having a trough formed in the sheet that extends between the bosses.

According to one embodiment of the invention, the trough extends up to and terminates at the bosses.

In accordance with another embodiment of the invention, a method of stacking plastic egg cartons one on top of the other is provided, each egg carton having a length and a width and comprising a lid and a tray hingedly connected to the lid; the tray having a plurality of cells for receiving individual eggs, the cells being arranged successively adjacent each other along the width and along the length of the carton, each cell having an under-surface forming a bottom of the tray, the under-surface of the cells forming a series of recesses between adjacent cells on the bottom of the tray, a pair of bosses having a selected upper surface contour above a top surface of the lid such that the bosses project upwardly from the top surface of the lid, the pair of bosses being arranged at opposing positions disposed along the length or width of the carton, the method comprising:
stacking one carton on top of another carton such that the two complementary recesses on the bottom of the one carton each receive one of the pair of bosses on the top surface of the lid of the other carton.

In accordance with one embodiment of the invention, the pair of bosses and the two complementary recesses are disposed at about the centerline of the width or length of the carton.

In accordance with one embodiment of the invention, the pair of bosses have a size and configuration such that when the pair of bosses are received within the recesses on the bottom of another one of the cartons, lateral and/or longitudinal movement of the cartons relative to each other is restricted.

In accordance with one embodiment of the invention, the bosses are disposed at about the centerline of the length or width of the carton.

In accordance with one embodiment of the invention, the bosses are arranged along or adjacent the lengthwise or widthwise edges of the carton.

In accordance with one embodiment of the invention, the method includes transporting the stacked cartons.

In accordance with one embodiment of the invention, the method includes transporting the stacked cartons on a pallet.

In accordance with one embodiment of the invention, the method includes transporting the stacked cartons on a pallet without providing exterior support to the stack.

In accordance with one embodiment of the invention, the method includes transporting the stacked cartons on a pallet with only an outer film wrap supporting the stacked cartons.

### BRIEF DESCRIPTION OF THE DRAWINGS

The drawings depict various embodiments of the invention wherein:

FIG. 1 is a top left perspective view of a 4×6 matrix egg carton according to one embodiment of the invention showing the lid closed over on top of the bottom tray portion that receives the eggs;

FIG. 2 is top plan view of the FIG. 1 carton;

FIG. 3 is a front view of the FIG. 1 carton;

FIG. 4 is a back view of the FIG. 1 carton;

FIG. 5 is a side view of the FIG. 1 carton;

FIG. 6 is bottom plan view of the FIG. 1 carton;

FIG. 7 is a front view of three FIG. 1 cartons stacked one on top of each other;

FIG. 8 is a sectional view taken along lines 8-8 of FIG. 7;

FIG. 9 is a sectional view taken along lines 9-9 of FIG. 8;

FIG. 10 is a side view of a pallet of stacked FIG. 1 cartons showing a crane depositing another group of stacked FIG. 1 cartons on top of the stack already on the pallet;

FIG. 11 is a side view of a stack of cartons wrapped in film on a pallet;

FIG. 12 is a perspective view of an alternative embodiment of an egg carton wherein the outer edges of the bosses reside beyond the edge of the lid top wall; and

FIG. 13 is a sectional view showing a boss of the carton of FIG. 12 engaging a cell of an adjacent carton.

### DETAILED DESCRIPTION

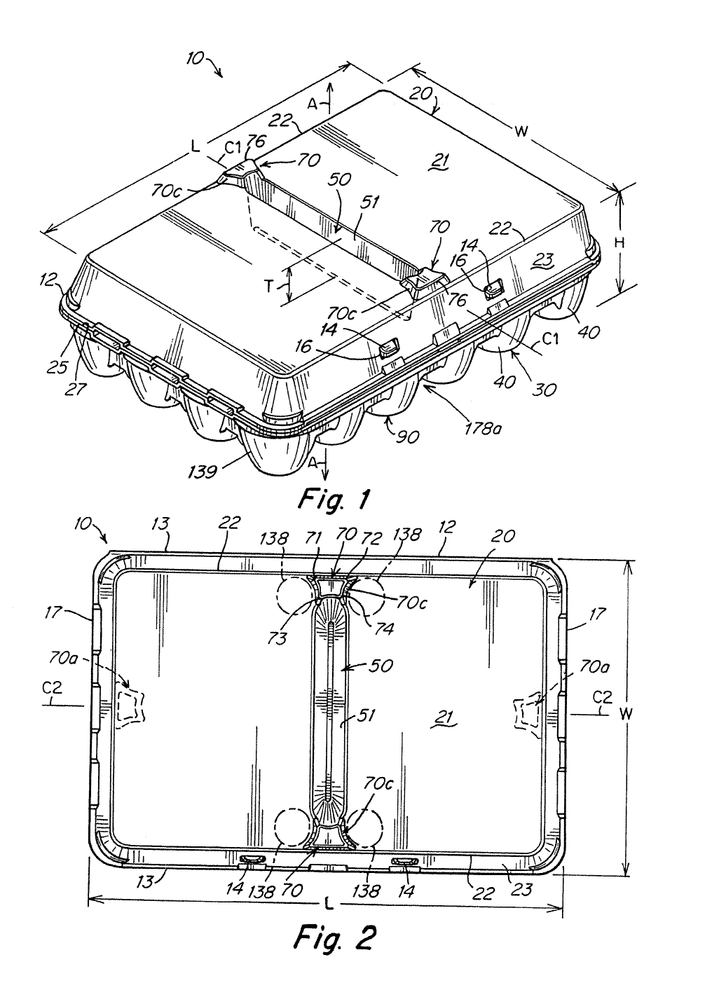

FIG. 1 shows in perspective view an egg carton 10 according to one embodiment of the invention. The carton 10, having general overall dimensions of length L, width W and height H, is comprised of a lid 20 connected via a hinge 12 to a base tray 30, the tray comprising a plurality of egg receiving cells 40 arranged in a matrix. The carton 10 is typically integrally molded from a sheet of polystyrene foam which is formed into an end product having the components described herein via conventional molding processes, e.g., pressing a foam sheet between male and female dies to form shaped lid and base portions and then removing (trimming) any remaining portions of the sheet to form an integral carton. The formation and structure of components such as the hinge 12, base locking nubs 14, associated lid flap and locking apertures 16, cells 40 and the like are shown and described in the prior art such as in U.S. Pat. No. 6,012,583 and U.S. Pat. No. 5,494,164 the disclosures of which are incorporated herein by reference as if fully set forth herein.

As shown in FIGS. 1-2 the lid 20 has a generally flat (planar) upper surface 21 and a peripheral sidewall 23 extending downwardly to a peripheral lower edge 25 that mates with a peripheral upper edge 27 of the base tray. The lid 20 top wall is molded to include a recessed trough 50 disposed at and along a centerline C1 transverse to length L of the carton 10. A pair of bosses 70 are provided, one at each end of the trough 50, the bosses having a preselected contour, e.g., size, shape, height P, geometry and/or configuration. The bosses are formed in the lid 20 as protrusions that extend axially A above the planar surface 21 of the lid 20 by a distance P (see FIG. 5) which is preferably a minimum of about 3/16 inches.

The elongated trough 50 is disposed along the width W of the carton between the bosses 70, and in the embodiment shown, the ends of the trough 50 terminate in the bosses 70 which, as shown, are disposed with their outermost edges 76 adjacent the lengthwise edges 22 of the lid 20. The trough 50 is formed within the body of the lid 20 as a generally elongated rectangular depression within the body of the planar surface 21 having elongated continuous walls 51 that extend axially A downwardly and below the planar surface 21 by a distance T, (see FIG. 1), in the opposite axial direction from the upward axial distance of projection P of bosses 70 (see FIG. 5). The walls 51 of the trough 50 preferably extend axially downwardly toward the tray 30 a sufficient distance T to enable the walls 51 to reinforce the lid and/or to laterally engage and act as a barrier or wall to protect eggs that are deposited within those cells 136, 138 that are immediately adjacent the lengthwise centerline C1 (or widthwise centerline C2 if the trough is aligned along the length) of the tray. Thus by extending a sufficient distance T from the top 21 downwardly toward the tray 30, the walls 51 can reinforce the lid (increase the mechanical strength of the carton), and in particular reinforce the bosses (to facilitate stacking without undue movement of the cartons with respect to one another) and/or engage and prevent eggs in the two rows of cells immediately adjacent the centerline (C1) from moving laterally within the tray 30. As shown, the bosses 70 are disposed at and along about the centerline C1 of the length of the carton 10. Alternatively, the bosses 70 and the trough 50 could be formed and disposed at and along about the centerline C2 of the width W of the carton 10, the location of such bosses 70a being shown in schematic in FIG. 2. In such an embodiment, the trough 50 can be formed in and extend between bosses 70a along the centerline C2 of the width W.

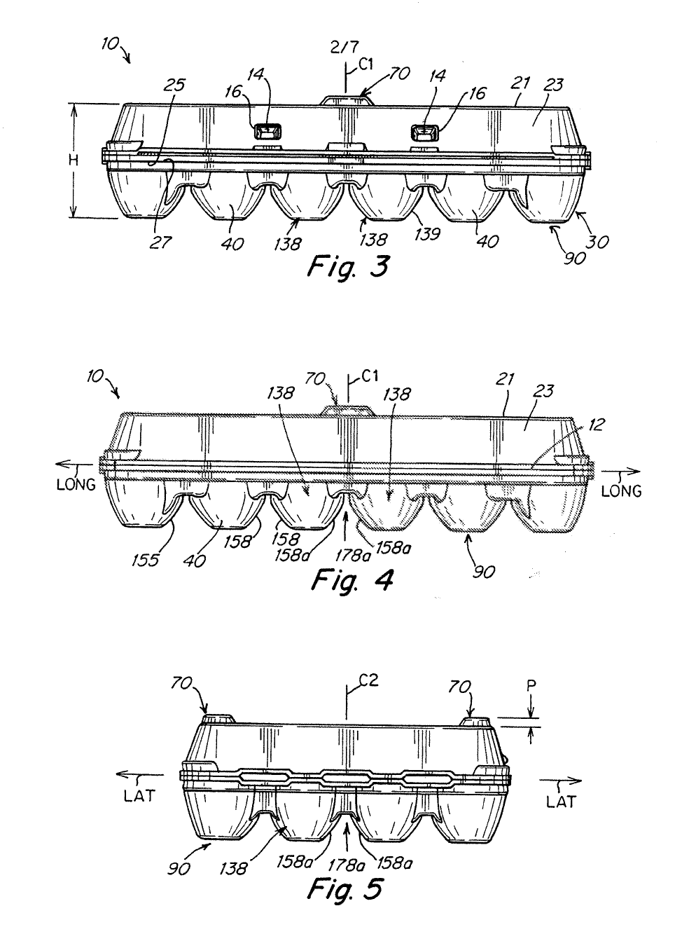

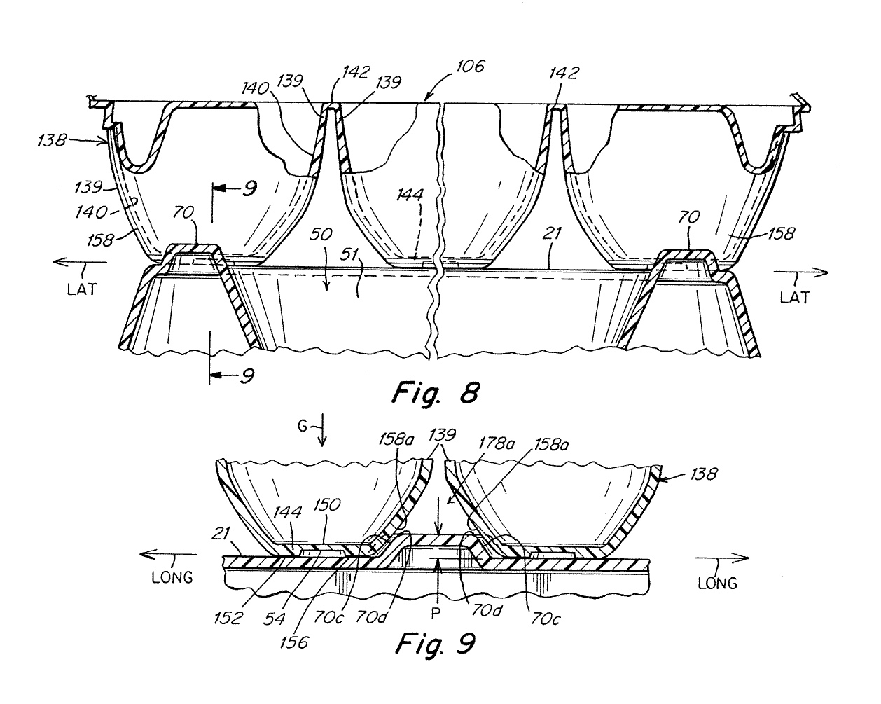

As shown the tray portion 30 of the carton 10 comprises a series of egg receiving cells 40 each formed to receive and accommodate a single egg. Each of the cells 40 is formed with a side wall 139 (see FIG. 8) having an inner receiving surface 140 contoured to receive the ovoid shape of an egg. The side wall 139 extends upwardly to define an open top and, where there is an adjoining cell joins with the sidewall 139 of the adjoining cell 106, with the two side walls 139 cooperatively defining a cell junction 142 (see FIG. 8). The cell junction 142 has generally at least one rounded shoulder which blends into a raised upper edge. The upper edge is flexible to respond to pressure applied by packaged eggs and provides protection therefor. Preferably, the carton comprises an even number of cells (for example 2, 4, 6, 8, 10, 12, etc.) serially interconnected either widthwise or lengthwise such that the bosses 70 or 70a can be positioned at about the center line or point between two adjacent cells while simultaneously being disposed at about the centerline C1 or C2 of either the length L or width W of the carton 10 along which an even number of cells are serially interconnected in a straight sequence. In the embodiment shown in FIGS. 1-10, the carton 10 comprises 6 rows of 4 cells extending along the width W, or 4 rows of 6 cells extending along the length L of the carton 10. Typical other cell matrix formats are 2×4, 3×6, 3×4, 4×4, 4×6, 5×6 and 6×6. By way of example only, the polystyrene foam 4×6 matrix carton shown in FIGS. 1-10 is designed to hold 24 extra large eggs, and is about 8 inches in width, about 11⅝ inches in length, and about 2¾ inches in height; each boss is about 1 inch long and about ½ inch wide and about 3/16 inches deep; the trough is about 5¾ inches long and about ¾ inches wide (at the top end) and about 1⅛ inches deep; the base tray is about 1½ inches deep; the lid is about 1½ inches deep; and each cell (at the top edge) is about 1⅞ inches in length and 1⅞ in width. This is given by way of example only and is not meant to be limiting.

As shown in FIG. 6, the carton 10 has corner cells 135, exterior cells 138 and interior cells 136, the exact positioning of which results in recesses 175, 176, 178 formed between the exterior surfaces of the cells 135, 136, 138 on the bottom face 90 of the carton 10 having configurations peculiar to the precise position of the various cells 135, 136, 138. Generally, the contour of the bottom outside cell surfaces 155, 156, 158 (of cells 135, 138, 136 respectively) are similar to each other such that the recesses 175, 176, 178 formed between adjacent cell outside surfaces 155, 156, 158 are similar in contour.

The contour of the upper or outside surfaces of the bosses 70, 70a (e.g., the size, shape, height, width, depth and/or configuration of the bosses 70 or 70a) are selected and formed to be complementary to the contour of at least two of the recesses 175, 176, 178 such that each of the bosses 70 or 70a can be readily inserted into a recess. Preferably, the contour of the bosses 70, 70a are formed to be complementary to the contour of those recesses that are formed between the outside surfaces of two adjacent outside cells 138, and more particularly the recesses 178 that are formed between the adjacent sidewall surfaces 158a of two adjacent exterior cells 138 that are also disposed immediately adjacent or straddle the centerline C1 of the length L (or C2 of the width W) of the carton 10 along an outer lengthwise edge 13 (or widthwise edge 17) of the tray 10. FIG. 2 shows this arrangement, where the arcuate sidewall contours 70c of the bosses are aligned to engage the outer circular contours of the two adjacent exterior cell sidewalls 138 to resist longitudinal and lateral movement therebetween. In this embodiment, the four corners 71, 72, 73, 74 (see FIG. 2) of the boss 70 provide four potential points of engagement with the adjacent cells 158 (defining the recess 178) to effectively limit/resist both longitudinal and lateral movement between the stacked cartons.

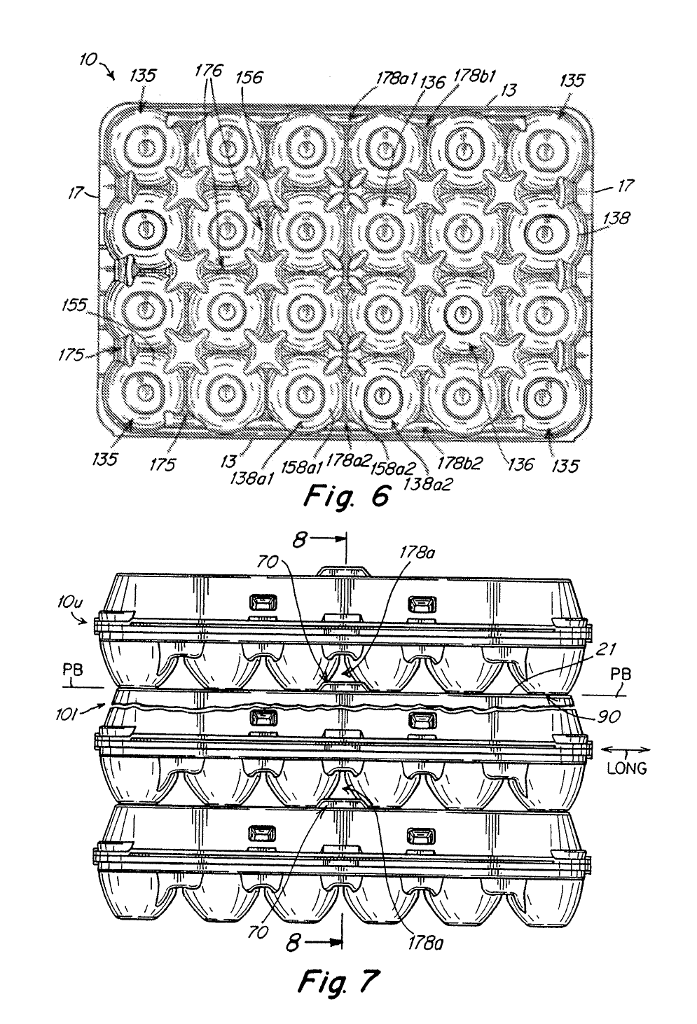

This is further illustrated in FIGS. 7-9 where the two bosses 70 (or 70a) are formed and disposed in predetermined positions on the top surface 21 of the lid 20 that match and are complementary in position to the positions on the bottom 90 of the carton 10 of at least two recesses, such as recesses 178a1 and 178a2. By such complementary positioning of at least two recesses 178a1 and 178a2, the two bosses 70 (or 70a) can be readily inserted into these two recesses such that one carton 10u can be stacked on top of another 10l carton (as shown in FIG. 7) rendering the two cartons aligned and resistant to lateral LAT and/or longitudinal LONG movement relative to each other by virtue of the two separate bosses 178a1, 178a2 being engaged or engageable against the bottom outside surfaces 158a1, 158a2 of the adjacent cells 138a1, 138a2 that form the recesses when the two stacked cartons 10u, 10l are moved laterally LAT and/or longitudinally LONG relative to each other.

In alternative embodiments, one or more additional bosses (in addition to the pair show in FIG. 1) may be provided to lie within other recesses, between either exterior or interior cell walls. Alternatively, the pair of bosses may be provided not on a centerline. Preferably at least two bosses are provided adjacent or along opposing side edges of the carton, either the lengthwise or widthwise edges. In one embodiment, a first pair of bosses is provided adjacent or along the lengthwise edges and a second pair of bosses is provided adjacent or along the widthwise edges.

As shown in FIGS. 8-9, the outside surface contour of the bosses 70 (or 70a) is smooth and is preferably formed with sloped outer surfaces 70c and/or smooth curvilinear or curved outer edges 70d that are configured so as to readily slide against the bottom outside surfaces 158, 158a of the cells if and when the boss surfaces 70c, 70d may come into contact with the outside surfaces 158, 158a of the cells 178, particularly when the bottom 90 of one carton 10u is mechanically positioned above and lowered onto the top side of another carton 10l. During such stacking and lowering process the user/operator (and/or machine) performing the stacking will attempt to mechanically align the bosses 70 (or 70a) with the recesses 178a1, 178a2 for insertion of the bosses 70 (or 70a) within a pair of complementarily positioned recesses, 178a1, 178a2. Such mechanical alignment by the user cannot be perfect and the sloped, curved and curvilinear surfaces 70c, 70d, 158, 158a serve to facilitate insertion of the bosses into the complementary recesses and thus result in better longitudinal and lateral alignment of two cartons 10u, 10l during the stacking process.

The side wall 139 in each of the cells extends downwardly to a base wall 144. In one embodiment, the base wall 144 is formed with a flat interior bottom surface 150 and a flat annular exterior bottom surface 152, the annular surface 152 having a central raised button portion 154 defined therein (see FIG. 9). The raised button portion 154 may be formed by densifying the polystyrene material of the base wall 144. The cells 135, 136, 138 are collectively formed such that the exterior bottom surfaces 152 of all of the cells 135, 136, 138 of one carton 10u are substantially co-planar to form a substantially stable planar bottom surface PB (see FIG. 7), that can readily engage and mate with the flat planar top surface 21 of another carton 10l when the one carton 10l is mechanically stacked or deposited on top of another carton 10u. By force of gravity G (see FIG. 9), the bottom surfaces 152 bear against top surface 21 to provide a degree of stability against lateral LAT and longitudinal LONG movement due to friction between surface 21 and surfaces 152.

To provide further stability against lateral LAT and/or longitudinal LONG movement, the bosses 70 (or 70a) most preferably are formed with an outside upper surface contour that are complementary (conform) to the contour of the complementary recesses 178a1, 178a2 into which the bosses are intended to be inserted. Such complementary contouring of the bosses to the intended complementary recesses enables the bosses to project into and reside within the depth of the complementary recesses when the bottom surfaces 152 of the bases 144 of the cells 135, 136, 137 engage the top surface 21. If and when a carton 10u moves laterally LAT or longitudinally LONG relative to carton 10l, the outside surfaces 70c, 70d of the bosses will contact, engage and interfere with the bottom outside surfaces 158, 158a of the cells 178 thus preventing the upper stacked carton 10u from moving or otherwise becoming not aligned on top of the lower disposed carton 10l. As shown in FIGS. 7-9, surfaces 70c are formed to be complementary in contour to the surfaces 158a, surfaces 70c having a partial egg-shape similar to the partial egg-shape of surfaces 158a.

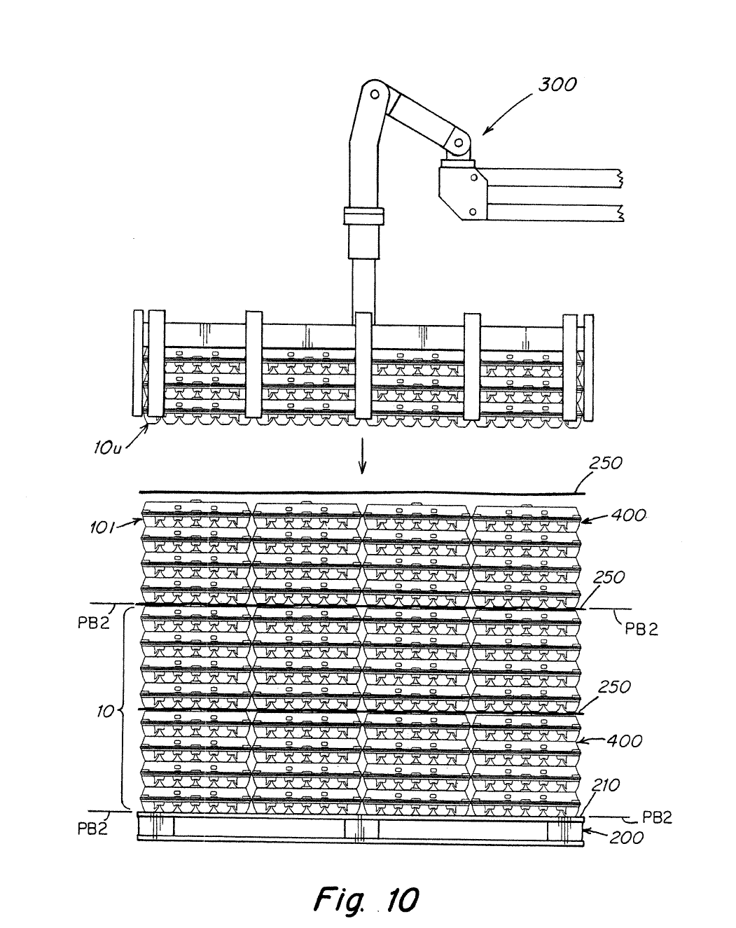

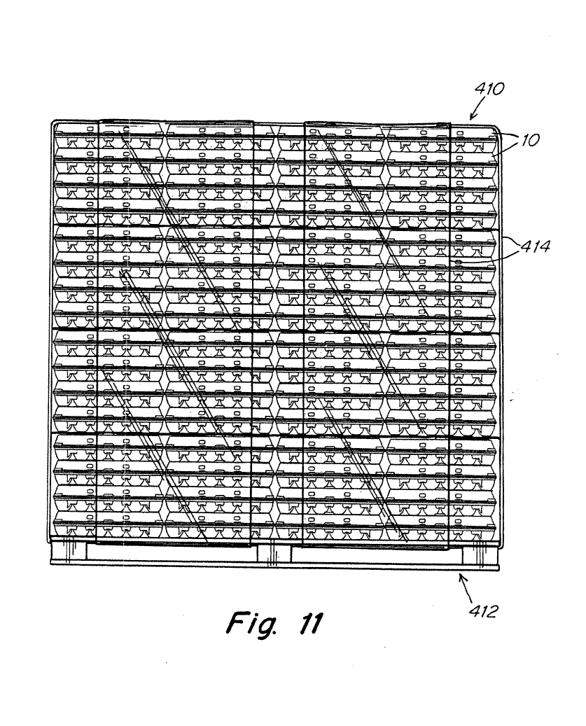

As shown in FIG. 10, in one embodiment a method and system is provided for stacking cartons 10 on the top planar surface 210 of a readily transportable pallet 200 (typically via forklift or crane 300) without the necessity of enclosing the stacked cartons 10, 10l, 10u within a container such as a box or cage or the like. As shown, the cartons 10 are stacked vertically in series in direct top 21 to bottom PB contact with each other, one on top of each other in collective depths of preferably 3-6 cartons. Slip sheets 250 are preferably disposed between stacks of 3-6 cartons in vertical depth. The slip sheets 250 typically comprise a flexible sheet of paper, plastic or cloth that can be deposited on top of and extend across the top surfaces 21 of a horizontal layer of multiple side-by-side horizontally arranged cartons 400, typically anywhere from about 2 to about 10 cartons horizontally across. As described above, the coplanar bottom surfaces 152 of the cartons 10 form a planar bottom surface PB which collectively among multiple cartons stacked at the same vertical level form a planar bottom PB2 such that when multiple cartons 10 are deposited side-by-side 400 on a slip sheet 250, the friction between PB2 and the slip sheet 250 provides an additional stability against lateral LAT and longitudinal LONG movement relative to the cartons on which they are stacked.

In another embodiment, shown in FIG. 11, a stack 410 of cartons 10 is disposed on a pallet 412 and the stacked cartons are wrapped in plastic film 414 (around the perimeter of the stack). The film provides the only outer packaging supporting the stack of egg cartons on the pallet.

The stackable egg cartons of the present invention can, if desired, also be packaged in existing standard master corrugated containers, such as one-half and full cases, plastic and wire baskets, and carts. For example: (a) a corrugated paper container (case), where a full case typically holds 30-dozen 2×6 egg cartons, and a half case holds 15-dozen 2×6 egg cartons; (b) plastic and metal grid baskets where each basket (a half case) typically holds 15-dozen 2×6 egg cartons; (c) milk crates, where each crate typically holds between 12-dozen jumbo 2×6 egg cartons (for jumbo size eggs) and 15-dozen regular egg cartons, (for medium, large and/or extra large eggs); and (d) racks designed to be wheeled or slid into grocery store display cases, where each rack typically holds between 240 to 360 2×6 egg cartons.

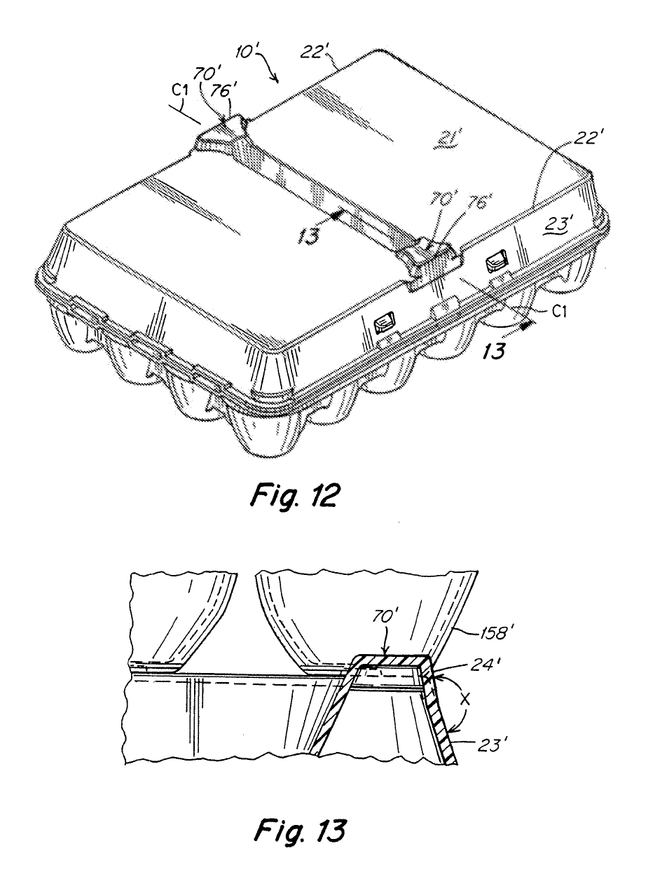

In another alternative embodiment shown in FIGS. 12-13, an egg carton 10′ is the same as the egg carton 10 of FIG. 1, the only difference being the pair of bosses 70′ are moved outwardly along the centerline C1 of the lid 20′. Here the outer edges 76′ of the bosses 70′ reside beyond the lengthwise (or alternating widthwise) edges 22′ of the carton. As shown in FIGS. 12-13, the bosses 70′ are supported by an outwardly angled portion 24′, extending away from the upper lid surface 21′, of the lid sidewall 23′. This angled support portion 24′ extends further toward the periphery of the adjacent egg carton cell bottoms 158′ to provide enhanced support and stability. Here the more vertically disposed angled portion 24′ is disposed at a angle X of 172° with respect to the sidewall 23′.

In various embodiments, the plastic egg carton is made of a thermoplastic which is foamed or unfoamed, and comprises one or more of polystyrene, polyester (e.g., polyethylene terephithlate (PET), polyolefin (e.g., polyethylene (PE), polypropylene (PP)), and poly(lactic acid) (PLA), including homopolymers, copolymers, mixtures and blends thereof, and including virgin and reclaimed materials.

It is to be understood that the foregoing description is intended to illustrate and not limit the scope of the invention.

1. An egg carton comprising:
a stackable egg carton of plastic material having a lid and a tray hingedly connected to the lid, said egg carton having a width and length;
the tray having a plurality of cells for receiving individual eggs, the cells being arranged successively adjacent each other along the width and along the length of the carton,
each cell having an under-surface forming a bottom of the tray,
the under-surface of the cells forming a series of recesses between adjacent cells; and
a pair of bosses projecting upwardly from an outer top surface of the lid, the pair of bosses being arranged at opposing ends along the length or width of the carton for positioning between two recesses of an adjacent carton stacked on top thereof, wherein the two recesses restrict movement of the bosses for maintaining the cartons in a stacked configuration.

2. The carton of claim 1, wherein the lid has a trough that extends between the bosses.

3. The carton of claim 2, wherein the trough extends up to and terminates at the bosses.

4. The carton of claim 2, wherein the trough has a width that is about the same as a width of the bosses.

5. The carton of claim 1, wherein the bosses have an upper surface contour that is complementary to a contour of the two recesses to resist lateral and/or longitudinal movement of the cartons relative to each other.

6. The carton of claim 1, wherein the pair of bosses is disposed at about the centerline of the length or of the width of the carton.

7. The carton of claim 6, wherein the bosses are arranged along or adjacent the opposing lengthwise or widthwise edges of the carton.

8. The carton of claim 1, wherein the bosses are disposed beyond the lengthwise or widthwise edges of the lid and are supported by angled portions of a lid sidewall.

9. The carton of claim 1, wherein the bosses are arranged along or adjacent the lengthwise edges of the carton.

10. The carton of claim 1, wherein the plastic comprises a thermoplastic which is foamed or unfoamed, and comprises one or more of polystyrene, polyester, polyolefin, and poly(lactic acid), including homopolymers, copolymers, mixtures and blends thereof, and including virgin and reclaimed materials.

11-17. (canceled)

18. A plastic egg carton for packaging a plurality of eggs, said egg carton having a width and a length, the carton comprising:
a lid and a tray hingedly connected to the lid;
the tray having a plurality of cells for receiving individual ones of the eggs, the cells being arranged successively adjacent each other along the width and along the length of the carton,
the lid having a top surface and being pivotable around the hinged connection into a closed position enclosing the cells,
each cell having an under-surface forming a bottom of the tray, the under-surface of the cells forming a series of recesses between adjacent cells, the top surface of the lid having a pair of bosses projecting upwardly from the top surface of the lid, the pair of bosses being arranged at opposing ends along the length or width of the carton;
the bosses having an upper surface contour that is complementary to a selected contour of at least two recesses on the bottom, the at least two complementary recesses being arranged on the bottom for simultaneous receipt of a pair of bosses on the lid of a carton when the lid is in a closed position;
wherein when the pair of bosses are received within the at least two complementary recesses on the bottom of another one of the cartons, the complementary contours of the bosses and recesses resist lateral and/or longitudinal movement of the cartons relative to each other.

19. The egg carton of claim 18, wherein the tray comprises a 2×6, 3×6, 4×6, 5×6 or 6×6 matrix of cells.

20. The egg carton of claim 18, wherein the plastic comprises a thermoplastic which is foamed or unfoamed, and comprises one or more of polystyrene, polyester, polyolefin and poly(lactic acid), including homopolymers, copolymers, mixtures and blends thereof, and including virgin and reclaimed materials.

21-23. (canceled)

24. A method of stacking plastic egg cartons one on top of the other, each egg carton having a length and a width and comprising a lid and a tray hingedly connected to the lid; the tray having a plurality of cells for receiving individual eggs, the cells being arranged successively adjacent each other along the width and along the length of the carton, each cell having an under-surface forming a bottom of the tray, the under-surface of the cells forming a series of recesses between adjacent cells on the bottom of the tray, a pair of bosses having a selected upper surface contour above a top surface of the lid such that the bosses project upwardly from the top surface of the lid, the pair of bosses being arranged at opposing positions disposed along the length or width of the carton, the method comprising:
stacking one carton on top of another carton such that the two complementary recesses on the bottom of the one carton each receive one of the pair of bosses on the top surface of the lid of the other carton.

25. The method of claim 24, wherein the pair of bosses and the two complementary recesses are disposed at about the centerline of the width or length of the carton.

26. The method of claim 24, wherein the pair of bosses have a size and configuration such that when the pair of bosses are received within the recesses on the bottom of another one of the cartons, lateral and/or longitudinal movement of the cartons relative to each other is restricted.

27. The method of claim 24, wherein the bosses are disposed at about the centerline of the length or width of the carton.

28. The method of claim 24, wherein the bosses are arranged along or adjacent the lengthwise or widthwise edges of the carton.

29. The method of claim 24, including transporting the stacked cartons.

30. The method of claim 24, including transporting the stacked cartons on a pallet.

31-32. (canceled)
